(19) United States
(12) Patent Application Publication
(10) Pub. No.: US 2026/0156691 A1
(43) Pub. Date: Jun. 4, 2026

(54) DEFER SIGNAL COLLISION AVOIDANCE FOR PRIORITIZED EDCA OPERATION IN NEXT GENERATION WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/391,936

(22) Filed: Nov. 17, 2025

Related U.S. Application Data
(60) Provisional application No. 63/728,027, filed on Dec. 4, 2024.
(60) Provisional application No. 63/729,740, filed on Dec. 9, 2024.
(60) Provisional application No. 63/733,274, filed on Dec. 12, 2024.

(51) Int. Cl. H04W 74/08

(52) U.S. Cl. CPC H04W 74/0875

(57) ABSTRACT

Methods and apparatuses for defer signal collision avoidance for prioritized enhanced distributed channel access (PEDCA) operation. A method of wireless communication performed by a station (STA) includes performing a prioritized enhanced distributed channel access (PEDCA) procedure. The PEDCA procedure comprises generating a first defer signal (DS) having a content associated with a first basic service set (BSS); and transmitting the first DS at a fixed time boundary such that the first DS avoids collision with a second DS of a second STA. The second DS has a content associated with a second BSS that overlaps with the first BSS.

### CROSS-REFERENCE TO RELATED APPLICATIONS AND CLAIM OF PRIORITY

This application claims priority under 35 U.S.C. § 119 (e) to U.S. Provisional Patent Application No. 63/728,027, filed on Dec. 4, 2024; U.S. Provisional Patent Application No. 63/729,740, filed on Dec. 9, 2024; and U.S. Provisional Patent Application No. 63/733,274, filed on Dec. 12, 2024, each of which are hereby incorporated by reference in its entirety.

### TECHNICAL FIELD

This disclosure relates generally to wireless communication, and more specifically to defer signal collision avoidance for prioritized enhanced distributed channel access (PEDCA) operation in next generation Wireless Local Area Networks (WLANs).

### BACKGROUND

Wireless Local Area Network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for defer signal collision avoidance for PEDCA operation in next generation WLANs.

In one embodiment, a station (STA) comprises: a transceiver, and a processor operably coupled with the transceiver. The processor is configured to: perform a prioritized enhanced distributed channel access (PEDCA) procedure. To perform the PEDCA, the processor is configured to: generate a first defer signal (DS) having a content associated with a first basic service set (BSS); and transmit, via the transceiver, the first DS at a fixed time boundary such that the first DS avoids collision with a second DS of a second STA, the second DS having a content associated with a second BSS that overlaps with the first BSS.

In another embodiment, an AP comprises a transceiver, and a processor operably coupled with the processor. The processor is configured to: perform a PEDCA procedure. To perform the PEDCA, the processor is configured to: receive, via the transceiver, a first DS having a content associated with a first BSS from a first STA and a second DS having a content associated with a second BSS from a second STA, where the first BSS overlaps with the second BSS; and coordinate with a second AP such that the content of the first DS is common with the content of the second DS and that the first DS avoids collision with the second DS.

In yet another embodiment, a method of wireless communication performed by a STA includes performing a PEDCA procedure. The PEDCA procedure comprises generating a first DS having a content associated with a first BSS; and transmitting the first DS at a fixed time boundary such that the first DS avoids collision with a second DS of a second STA. The second DS has a content associated with a second BSS that overlaps with the first BSS.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of stages involved during a mobility handover procedure according to embodiments of the present disclosure;

FIG. 5 illustrates an example of a prioritized EDCA mechanism according to embodiments of the present disclosure;

FIG. 6 illustrates an example of an overlapping basic service set (OBSS) according to embodiments of the present disclosure;

FIG. 7 illustrates an example of defer signal (DS) collision according to embodiments of the present disclosure;

FIG. 8 illustrates an example of DS collision with a request-to-send (RTS) according to embodiments of the present disclosure;

FIG. 9 illustrates an example of DS collision with a RTS/data according to embodiments of the present disclosure;

FIG. 10 illustrates an example of DS collision with a legacy STA capturing the channel according to embodiments of the present disclosure;

FIG. 11 illustrates an example of DS collision with an OBSS-DS according to embodiments of the present disclosure;

FIG. 12 illustrates an example of DS transmission with uniform content across OBSS according to embodiments of the present disclosure;

FIG. 13 illustrates an example depicting coordination between OBSS access points (APs) to determine uniform content for DS according to embodiments of the present disclosure;

FIG. 14 illustrates an example same receiver address (RA) and duration when a CTS frame is used as the DS according to embodiments of the present disclosure;

FIG. 15 illustrates an example of APs using the same parameters as advertised by other APs in the vicinity according to embodiments of the present disclosure;

FIG. 16 illustrates an example with different BSS using different time boundaries according to embodiments of the present disclosure;

FIG. 17 illustrates an example of AIFSN variation to create fairness across OBSS according to embodiments of the present disclosure;

FIG. 18 illustrates an example of a response DS transmission according to embodiments of the present disclosure;

FIG. 19 illustrates an example PEDCA initiation failed count increment procedure according to embodiments of the present disclosure;

FIG. 20 illustrates an example PEDCA initiation failed count based eligibility criteria procedure according to embodiments of the present disclosure;

FIG. 21 illustrates an example PEDCA initiation failed count reset procedure according to embodiments of the present disclosure;

FIG. 22 illustrates an example of DS transmission following the channel captured by another STA according to embodiments of the present disclosure;

FIG. 23 illustrates an example of a channel being sensed as busy after transmission of DS according to embodiments of the present disclosure;

FIG. 24 illustrates an example of a channel being captured by a legacy STA following a DS transmission according to embodiments of the present disclosure;

FIG. 25 illustrates an example of DS collision between OBSS according to embodiments of the present disclosure; and

FIG. 26 illustrates an example method performed by a STA in a wireless communication system according to embodiments of the present disclosure.

### DETAILED DESCRIPTION

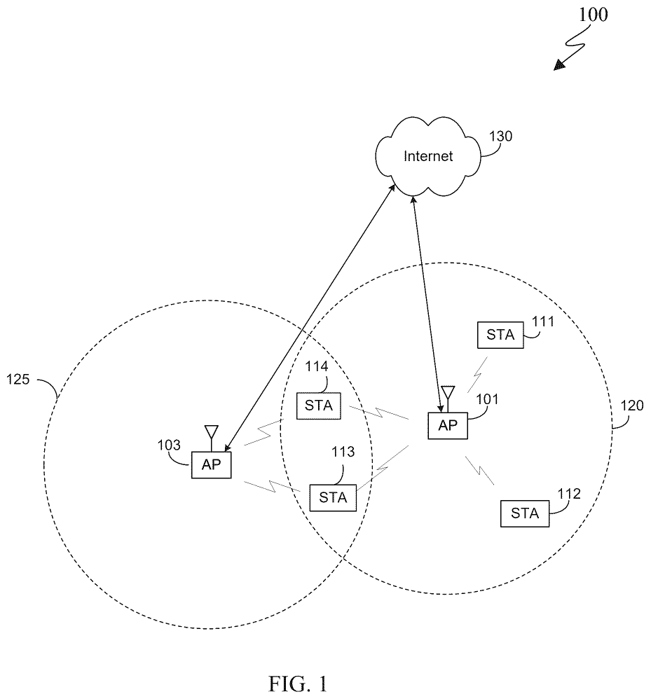

FIGS. 1 through 26, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D3.0, 2023; [2] IEEE Std 802.11-2020.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating defer signal collision avoidance for PEDCA operation in next generation WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

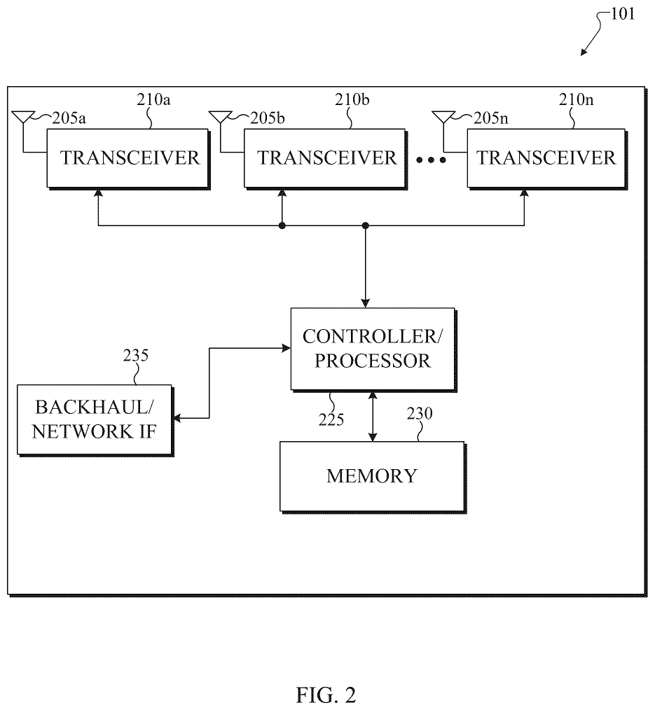

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating defer signal collision avoidance for PEDCA operation in next generation WLANs. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating defer signal collision avoidance for PEDCA operation in next generation WLANs. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted, and additional components could be added according to particular needs.

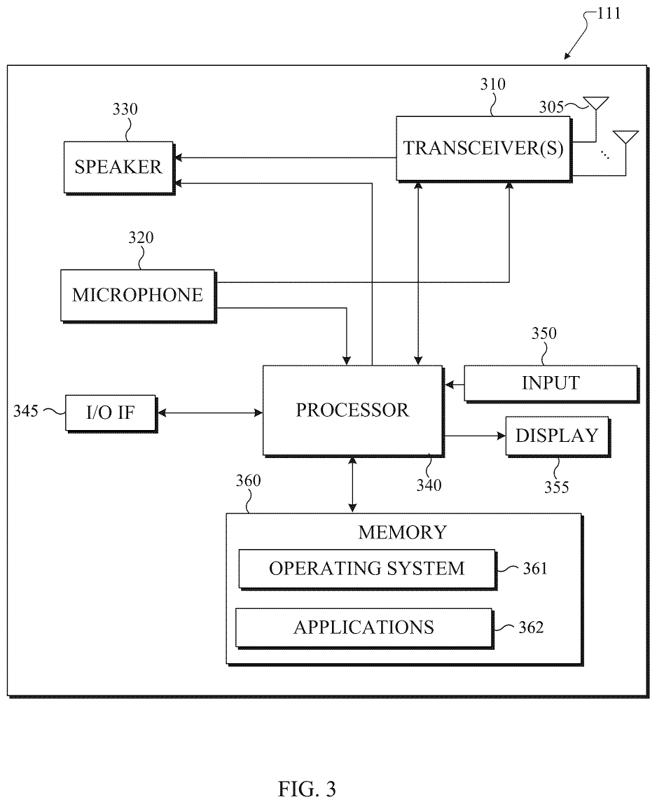

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate defer signal collision avoidance for PEDCA operation in next generation WLANs. In some embodiments, the processor 340 includes at least one microprocessor or microcontroller.

The processor 340 is also capable of executing other processes and programs resident in the memory 360, such as operations for facilitating defer signal collision avoidance for PEDCA operation in next generation WLANs. The processor 340 can move data into or out of the memory 360 as required by an executing process. In some embodiments, the processor 340 is configured to execute a plurality of applications 362, such as applications for facilitating defer signal collision avoidance for PEDCA operation in next generation WLANs. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

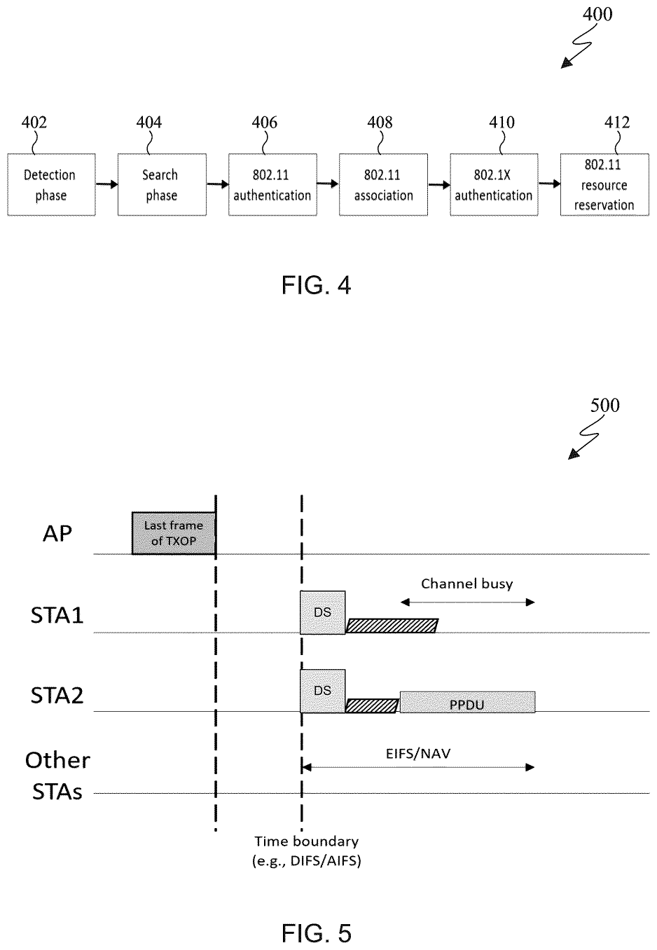

FIG. 4 illustrates an example of stages involved during a mobility handover procedure 400 according to embodiments of the present disclosure. For example, the mobility handover procedure 400 can be performed by any of the STAs 111-114, any of the APs 101, 103, and/or the network 130 of FIG. 1. The embodiment of the example of stages involved during a mobility handover procedure 400 shown in FIG. 4 is for illustration only. Other embodiments of the example of stages involved during a mobility handover procedure 400 could be used without departing from the scope of this disclosure.

As shown in FIG. 4, in legacy devices without any mobility support, the handover procedure involves the following steps:

1. Detection phase: during the detection phase 402, the STA determines that there is a need for a handover, and is typically left to vendor implementation. For example, a particular vendor implementation can choose to trigger handover when the signal strength to the currently associated AP drops below a certain threshold.

2. Search phase: the detection phase 402 is followed by a search phase 404. During the search phase 404, the STA searches for new APs to associate with. During the search phase 404, the STA performs a scan of different channels to identify APs in the vicinity. This can be done either passively (e.g., listening to beacons on a particular channel) or actively (e.g., by the use of probe request and response procedures). Passive scan can take a lot of time as the scanning STA needs to wait on each channel for a sufficient amount of time to ensure that the beacon is received from APs on that channel. Since each AP transmits beacons after a certain period of time (e.g., 100 ms), passive scan can consume a lot of time. In the case of active scan, the STA transmits a probe request and waits for a probe response from APs in the vicinity. Without prior knowledge of APs in the vicinity, active scan can take several seconds to complete.

3. 802.11 authentication: after the scanning procedure is complete, the next step is to perform 802.11 authentication 406 (open system/shared key based), where the STA establishes its identity with the AP.

4. 802.11 association: Once the STA is authenticated, the next step is to perform association 408.

5. 802.1X authentication: Introduced in IEEE 802.li amendment, the 802.1X authentication phase 410 comprises an EAP authentication between the STA and a AAA server with the assistance of the AP.

6. 802.11 resource reservation: Finally, in the 802.11 resource reservation phase 812, the STA sets up various resources at the new AP. For example, the STA can perform QoS reservation, BA setup, etc. with the newly associated AP.

Typically, during a handover, there can be a disruption in the connection as the setup procedure operates in a break-before-make manner. This can have an impact on user experience, especially with multimedia services which can suffer from session disruptions due to the high delay encountered during handover procedure.

In order to reduce the handover delay, a number of procedures have been introduced in several standards. The focus of these procedures is to remove/reduce the delay encountered in various steps of the handover procedure. In 2008, IEEE 802.11r introduced a fast transition roaming which eliminates the need for the authentication step 406 (step 3 above) during the handover. In 2011, IEEE 802.11k introduced assisted roaming which reduces the search phase 404 (step 2 above) by allowing the STA to request the AP to send channel information of candidate neighbor APs. In 2011, IEEE 802.11v also introduced network assisted roaming to assist the search phase 404. In IEEE 802.11be, the fast BSS transition procedure was extended to cover the case of MLO operation. This procedure helps to reduce the delays encountered due to 802.11 resource reservation (step 6 above).

FIG. 5 illustrates an example of a prioritized EDCA mechanism 500 according to embodiments of the present disclosure. The embodiment of the prioritized EDCA mechanism 500 shown in FIG. 5 is for illustration only. Other embodiments of the prioritized EDCA mechanism 500 could be used without departing from the scope of this disclosure.

Embodiments of the present disclosure recognize that in next generation WLANs, there can be a prioritized EDCA mechanism. As a part of the prioritized EDCA mechanism, a number of eligible STAs can transmit a defer signal (DS) at a fixed time boundary after the end of the previous transmission. The fixed time boundary can be determined in a number of ways, for example, short inter-frame space (SIFS) boundary, point coordination function inter-frame space (PIFS) boundary, distributed coordination function inter-frame space (DIFS) boundary, arbitrary inter-frame space (AIFS) boundary. After the transmission of the DS, legacy STAs and STAs that did not transmit the DS can avoid accessing the channel and a prioritized EDCA channel access procedure can begin which can involve contention between the STAs that transmitted the DS. The DS can be a CTS frame which can have the same content for STAs in a BSS. Thus, multiple DSs can be sent together without a collision. An example is shown in FIG. 5. Transmission of such a DS signal can enable STAs with certain types of traffic (e.g., voice traffic) to prevent other types of STAs from contending with them for the channel. This reduced channel access contention can enable eligible STAs to transmit their traffic while facing a lower delay from channel access.

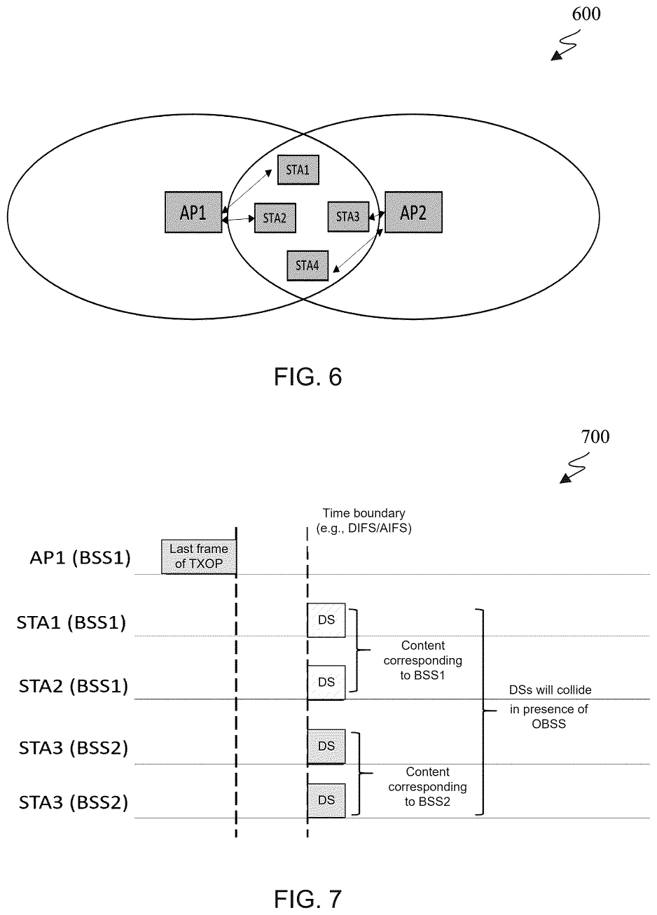

FIG. 6 illustrates an example of OBSS 600 according to embodiments of the present disclosure. The embodiment of the OBSS 600 shown in FIG. 6 is for illustration only. Other embodiments of the OBSS 600 could be used without departing from the scope of this disclosure.

FIG. 7 illustrates an example of defer signal (DS) collision 700 according to embodiments of the present disclosure. The embodiment of DS collision 700 shown in FIG. 7 is for illustration only. Other embodiments of DS collision 700 could be used without departing from the scope of this disclosure.

Embodiments of the present disclosure recognize that in the presence of OBSS, such DSs from different BSSs can collide. In one example, suppose that the AIFS boundary can be chosen as the time boundary at which the defer signal can be transmitted. Suppose that AP1 and AP2 use the same AIFSN value. As a result, STAs from AP1's BSS and STAs from AP2's BSS can transmit a DS at the same time boundary. Since the content of the DS from AP1's BSS can be different from the content of the DS from AP2's BSS, the transmission of a DS from the STAs in these two BSS at the same time can result in a collision of DS which cannot generate the intended effect of reducing the number of contending STAs on the channel. As a result, STAs in neither BSSs can benefit from the use of DS. FIGS. 6 and 7 illustrate the problem via an example.

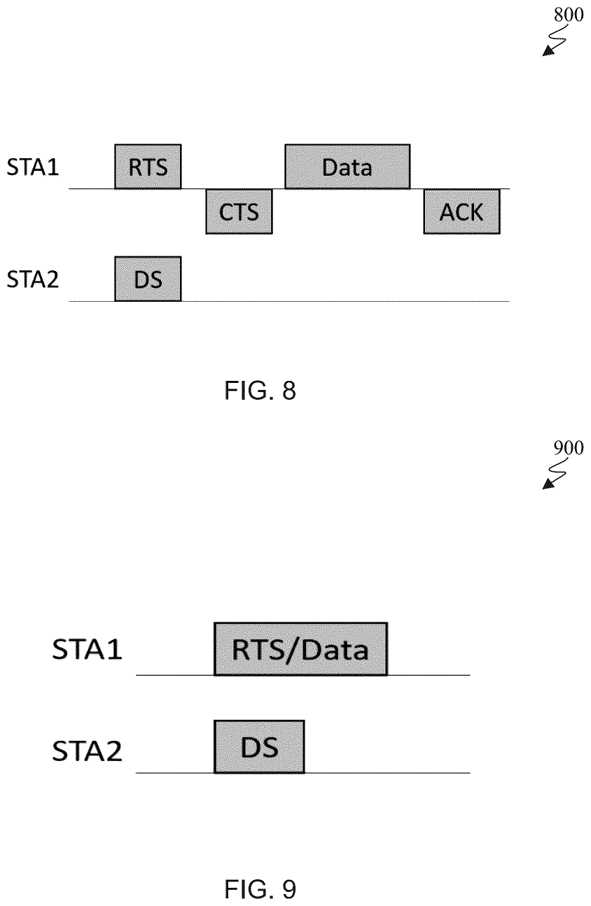

FIG. 8 illustrates an example of DS collision with a RTS 800 according to embodiments of the present disclosure. The embodiment of DS collision with a RTS 800 shown in FIG. 8 is for illustration only. Other embodiments of DS collision with a RTS 800 could be used without departing from the scope of this disclosure.

FIG. 9 illustrates an example of DS collision with a RTS/data 900 according to embodiments of the present disclosure. The embodiment of DS collision with a RTS/data 900 shown in FIG. 9 is for illustration only. Other embodiments of DS collision with a RTS/data 900 could be used without departing from the scope of this disclosure.

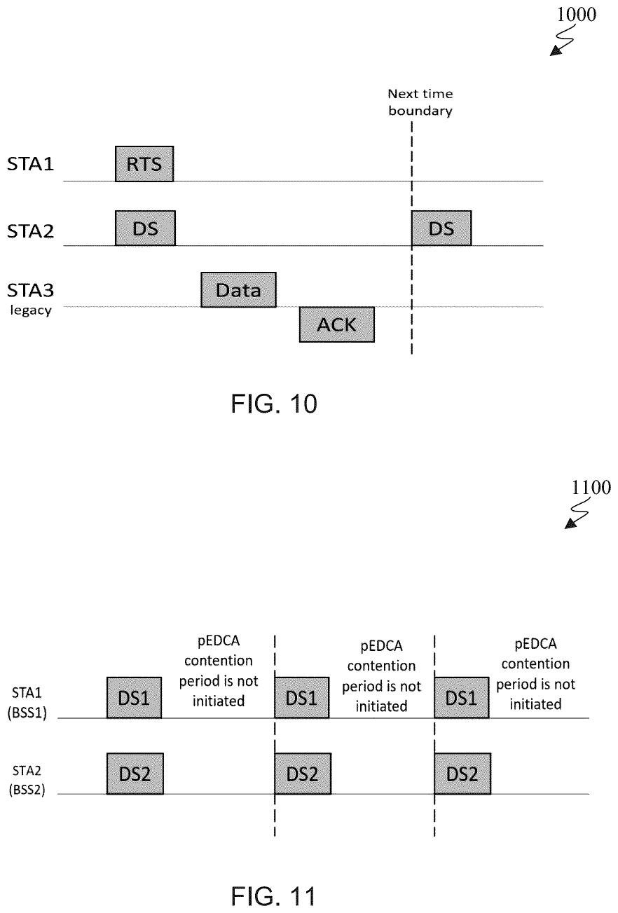

FIG. 10 illustrates an example of DS collision with a legacy STA capturing the channel 1000 according to embodiments of the present disclosure. The embodiment of DS collision with a legacy STA capturing the channel 1000 shown in FIG. 10 is for illustration only. Other embodiments of DS collision with a legacy STA capturing the channel 1000 could be used without departing from the scope of this disclosure.

FIG. 11 illustrates an example of DS collision with an OBSS-DS 1100 according to embodiments of the present disclosure. The embodiment of DS collision with an OBSS-DS 1100 shown in FIG. 11 is for illustration only. Other embodiments of DS collision with an OBSS-DS 1100 could be used without departing from the scope of this disclosure.

Embodiments of the present disclosure recognize that a PEDCA contention period can be initiated by transmission of a DS. However, it is possible that the DS transmission may not be successful (e.g., due to collision with another frame). In such a situation, the enhanced EDCA contention period may not be initiated successfully as legacy devices may not receive the DS successfully and may also contend for channel access. The procedure and behavior that the PEDCA initiating device should follow in such a situation needs to be defined. A few example scenarios are illustrated in FIGS. 8-11.

Embodiments of the present disclosure recognize that the STA can be using a prioritized EDCA (e.g., hip EDCA) which can be invoked by the STA based on a certain set of conditions, for example based on a retry count, delay bound values, etc. When a STA transitions from one AP to another, a procedure is needed to handle such parameters that the STA can use.

Accordingly, embodiments of the present disclosure provide a number of solutions for handling DS collision avoidance for prioritized EDCA operation, including 1) content uniformity across OBSS; 2) use of different time boundaries; and 3) response DS to avoid collision.

Further, embodiments of the present disclosure provide a number of solutions for handling PEDCA initiation failure in next generation WLANs, including 1) a PEDCA initiation failed count based method; 2) a retry count based method; and 3) an AIFSN randomization based method.

Further still, embodiments of the present disclosure provide a number of solutions for handling during roaming one or more parameters that are used to invoke a prioritized EDCA, including 1) reset values during roam transition; 2) carry forward values at the time of roam; and 3) an indication of value handling under a roaming procedure.

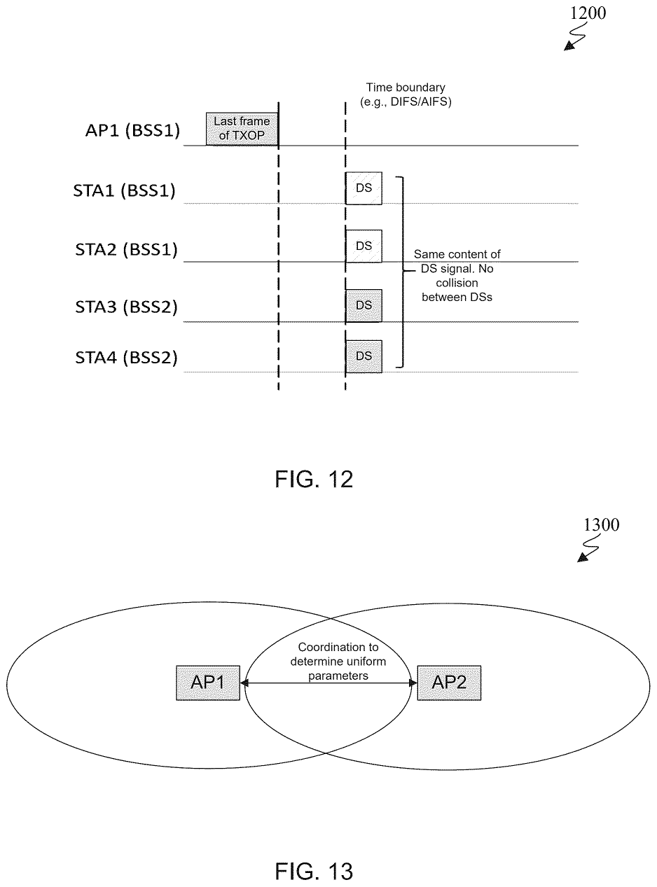

FIG. 12 illustrates an example of DS transmission with uniform content across OBSS 1200 according to embodiments of the present disclosure. The embodiment of DS transmission with uniform content across OBSS 1200 shown in FIG. 12 is for illustration only. Other embodiments of DS transmission with uniform content across OBSS 1200 could be used without departing from the scope of this disclosure.

According to one embodiment, as shown in FIG. 12, the DSs transmitted from different OBSS can have the same content. This can ensure that the DS don't collide with each other.

FIG. 13 illustrates an example depicting coordination between OBSS APs to determine uniform content for DS 1300 according to embodiments of the present disclosure. The embodiment of coordination between OBSS APs to determine uniform content for DS 1300 shown in FIG. 13 is for illustration only. Other embodiments of coordination between OBSS APs to determine uniform content for DS 1300 could be used without departing from the scope of this disclosure.

As shown in FIG. 13, according to one embodiment, when CTS is used as the DS, the duration and the RA fields can have the same value for DSs sent by STAs in different OBSSs. These values can be decided by the APs of the OBSS by coordinating with each other. The coordination can occur over the air or over the wired network.

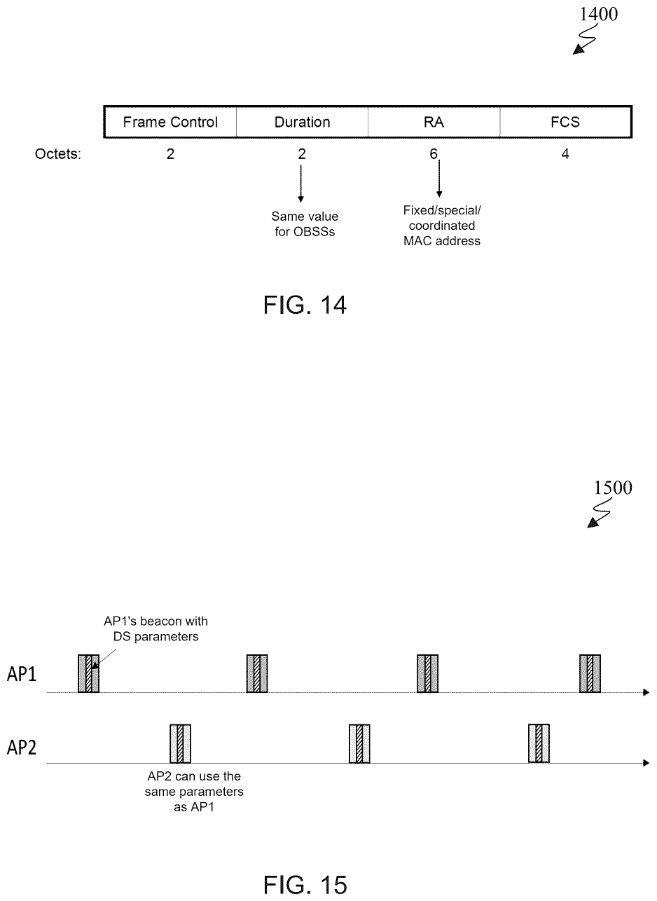

FIG. 14 illustrates an example same RA and duration when a CTS frame is used as the DS 1400 according to embodiments of the present disclosure. The embodiment of same RA and duration when a CTS frame is used as the DS 1400 shown in FIG. 14 is for illustration only. Other embodiments of same RA and duration when a CTS frame is used as the DS 1400 could be used without departing from the scope of this disclosure.

As shown in FIG. 14, according to one embodiment, the RA address can be a special value that is fixed by the specification. The value can be used by any STA that can participate in the prioritized EDCA. Examples of such special MAC address are FF:FF:FF:FF:FF:FF, 00:00:00:00:00:00, etc. In the same manner the duration field can be a fixed value in the specification. For example, the duration field may be a value that is sufficient to perform contention using the parameters of the AC that can participate in prioritized EDCA.

According to another embodiment, when the APs coordinate with each other, they can also decide one MAC address/ID which can be used in the RA field in the DS. For example, a MAP related identifier, a roaming ID, etc. This address can be advertised by the APs in their management frames. For example, beacons, probe responses, etc. The APs can also coordinate to decide the duration field value.

FIG. 15 illustrates an example of APs using the same parameters as advertised by other APs in the vicinity 1500 according to embodiments of the present disclosure. The embodiment of using the same parameters as advertised by other APs in the vicinity 1500 shown in FIG. 15 is for illustration only. Other embodiments of using the same parameters as advertised by other APs in the vicinity 1500 could be used without departing from the scope of this disclosure.

As shown in FIG. 15, each AP can scan its vicinity for existing APs and use the common address value and duration value advertised by these APs for prioritized EDCA purposes. For example, when an AP first comes up, it can scan the vicinity for other APs and check the common address value and duration value advertised by such APs. If no AP exists or no such value is found, the AP can choose its own values and other APs that scan for values at a later stage can start to use such values.

According to one embodiment, when an AP sets a value for the duration and RA field, it can remain the same for the lifetime of the BSS. According to another embodiment, the values can change over the lifetime of a BSS.

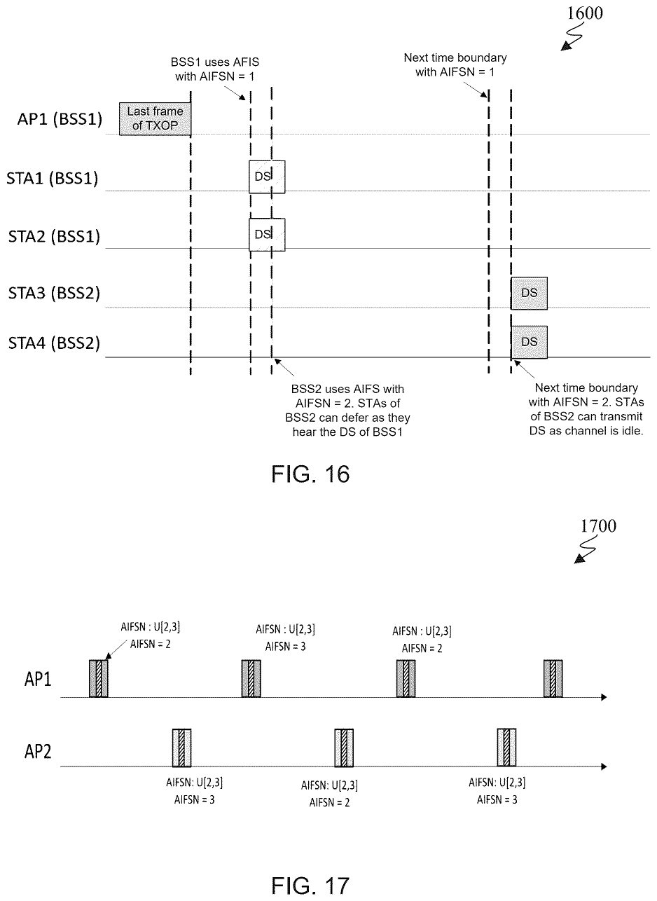

FIG. 16 illustrates an example with different BSSs using different time boundaries 1600 according to embodiments of the present disclosure. The embodiment of different BSS using different time boundaries 1600 shown in FIG. 16 is for illustration only. Other embodiments of different BSS using different time boundaries 1600 could be used without departing from the scope of this disclosure.

As shown in FIG. 16, according to one embodiment, different BSSs can use different time boundaries to avoid a DS collision.

According to this embodiment, an AP can advertise parameters that characterize its time boundary. The indication can be provided by one or more information items as indicated in Table 1.

TABLE 1
Information items that can be used to characterize the time boundary

| Information item | Description |
|---|---|
| AIFS related | One or more information items that can characterize the AIFS |
| parameters | value for transmission of the DS signal. E.g., SIFS, slot time, |
| | AIFSN, etc. |
| Time value | One or more information items that can describe the time |
| | boundary in terms of a timing parameter. E.g., the duration after |
| | the last frame of the previous TXOP to the time when the DS |
| | can be sent. This value can also be fixed in the specification. |
| Time boundary | One or more information items that can describe the time |
| indication | boundary. E.g., an encoding that can describe if the time |
| parameter | boundary for transmission of DS is a SIFS, PIFS, DIFS, AIFS, |
| | etc. |

APs can advertise these parameters in one or more frame that it can transmit. E.g., management frames such as beacons, probe responses, etc.

Other OBSS APs that hear such parameters can choose values that are different from other APs to avoid the same time boundary for transmission of the DS signal.

According to one embodiment, different OBSS APs can also coordinate with each other to determine different time boundaries or different parameters that lead to different time boundaries. Such coordination can occur over the air or over the wired network.

According to one embodiment, when APs set a value for a parameter that determines the time boundary, it can remain the same for the BSS for the lifetime of the BSS.

According to another embodiment, the value can change over the lifetime of the BSS. For instance, as a particular AP starts to serve higher priority traffic (e.g., low latency, EPCS, etc.), it can request for an earlier time boundary or parameters that result in an earlier time boundary from its neighboring OBSS APs. As the AP's high priority traffic session is complete, the AP can release this earlier time boundary to other neighboring OBSS APS.

FIG. 17 illustrates an example of AIFSN variation to create fairness across OBSS 1700 according to embodiments of the present disclosure. The embodiment of AIFSN variation to create fairness across OBSS 1700 shown in FIG. 17 is for illustration only. Other embodiments of AIFSN variation to create fairness across OBSS 1700 could be used without departing from the scope of this disclosure.

As shown in FIG. 17, according to one embodiment, the APs can randomly decide the AIFSN value from a particular/pre-known/pre-determined range/distribution in each or a selective set of beacons to vary the AIFSN and create fairness across OBSS.

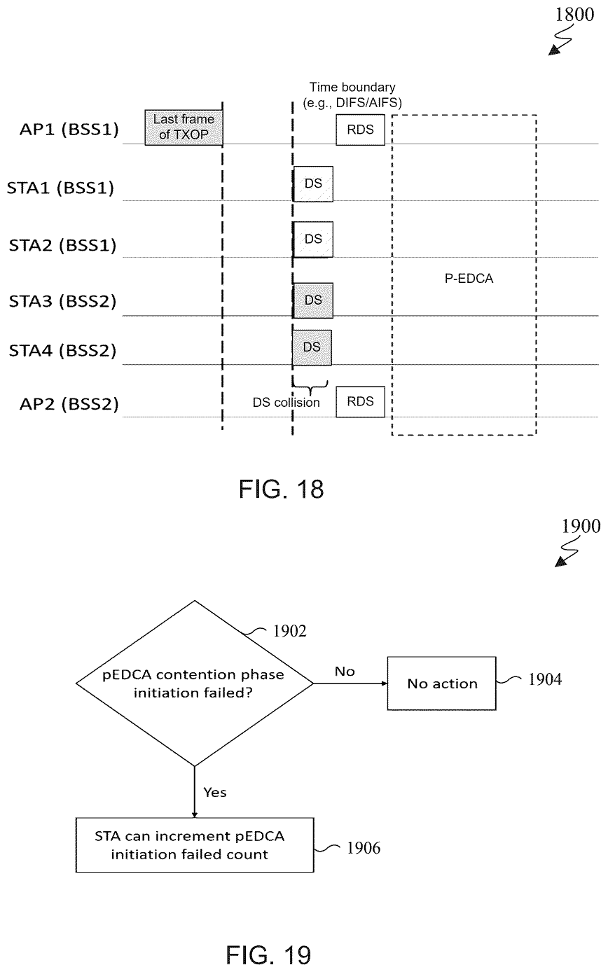

FIG. 18 illustrates an example of a response DS transmission 1800 according to embodiments of the present disclosure. The embodiment of a response DS transmission 1800 shown in FIG. 18 is for illustration only. Other embodiments of a response DS transmission 1800 could be used without departing from the scope of this disclosure.

As shown in FIG. 18, according to one embodiment, when an AP does not transmit a DS signal, it can detect the DS collision from OBSS and can transmit a response frame to the DS signal to initiate a prioritized EDCA. The RDS frame can have the same content and can be decided either by the specification or by the APs via coordination among themselves.

FIG. 19 illustrates an example PEDCA initiation failed count increment procedure 1900 according to embodiments of the present disclosure. The embodiment of a PEDCA initiation failed count increment procedure 1900 shown in FIG. 19 is for illustration only. Other embodiments of a PEDCA initiation failed count increment procedure 1900 could be used without departing from the scope of this disclosure.

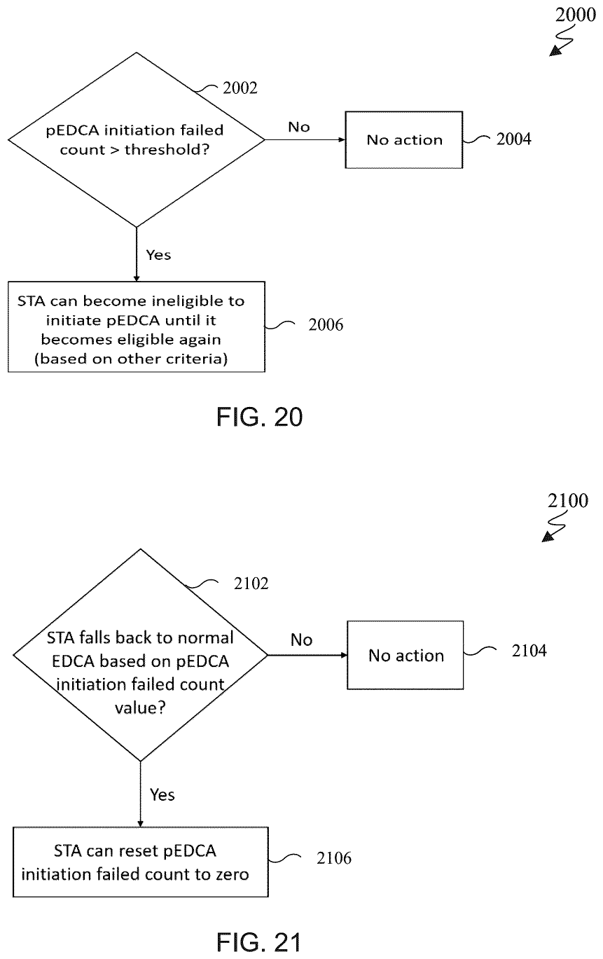

FIG. 20 illustrates an example PEDCA initiation failed count based eligibility criteria procedure 2000 according to embodiments of the present disclosure. The embodiment of a PEDCA initiation failed count based eligibility criteria procedure 2000 shown in FIG. 20 is for illustration only. Other embodiments of a PEDCA initiation failed count based eligibility criteria procedure 2000 could be used without departing from the scope of this disclosure.

As shown in FIGS. 19 and 20, according to some embodiments, the STA can keep a PEDCA initiation failed count and increment it each time it fails to enter into PEDCA contention phase after transmission of the DS. If the PEDCA initiation failed count exceeds a certain threshold, the STA can become ineligible for initiation of PEDCA unless it becomes eligible again based on other eligibility criteria.

For example, as illustrated in FIG. 19, at step 1902, a determination can be made whether a PEDCA contention phase initiation failed. If the PEDCA contention phase initiation did not fail, then at step 1904, no action can be taken. If the PEDCA contention phase initiation failed, then at step 1906, the STA can increment the PEDCA initiation failed count.

As illustrated in FIG. 20, at step 2002, a determination can be made whether the PEDCA initiation failed count exceeds a threshold. If the PEDCA initiation failed count does not exceed the threshold, then at step 2004, no action can be taken. If the PEDCA initiation failed count exceeds the threshold, then at step 2006, the STA can become ineligible to initiate PEDCA until it becomes eligible again (based on other criteria).

FIG. 21 illustrates an example PEDCA initiation failed count reset procedure 2100 according to embodiments of the present disclosure. The embodiment of a PEDCA initiation failed count reset procedure 2100 shown in FIG. 21 is for illustration only. Other embodiments of a PEDCA initiation failed count reset procedure 2100 could be used without departing from the scope of this disclosure.

When a STA becomes ineligible to initiate PEDCA based on PEDCA initiation failed count and falls back to normal EDCA, it can set the PEDCA initiation failed count value to 0. For example, as shown in FIG. 21, at step 2102, a determination can be made whether the STA falls back to normal EDCA based on the PEDCA initiation failed count value. If the STA does not fall back to normal EDCA based on the PEDCA initiation failed count value, then at step 2104, no action can be taken. If the STA falls back to normal EDCA based on the PEDCA initiation failed count value, then at step 2106, the STA can reset the PEDCA failed count to zero.

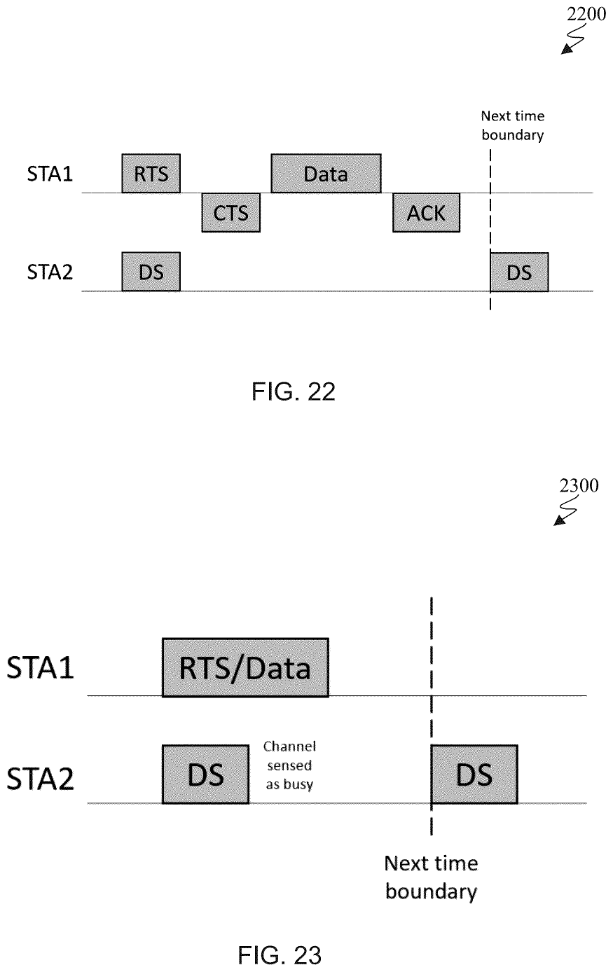

FIG. 22 illustrates an example of DS transmission following the channel being captured by another STA 2200 according to embodiments of the present disclosure. The embodiment of a DS transmission following the channel being captured by another STA 2200 shown in FIG. 22 is for illustration only. Other embodiments of a DS transmission following the channel being captured by another STA 2200 DS transmission following the channel being captured by another STA 2200 could be used without departing from the scope of this disclosure.

As shown in FIG. 22, according to one embodiment, when a DS collision occurs and the channel is captured by another STA following the DS transmission, the STA transmitting the DS can defer until the next time boundary for transmission of the DS and then send a DS if it still remains eligible to initiate PEDCA.

According to one embodiment, the STA can increment a PEDCA retry count by 1 each time the channel is captured by another STA that was not initiating a PEDCA.

According to one embodiment, the STA can keep the PEDCA retry count the same each time the channel is captured by another STA that was not initiating a PEDCA. Thus, the STA can still remain eligible based on the PEDCA retry count criteria to initiate PEDCA at the next time boundary.

FIG. 23 illustrates an example of a channel being sensed as busy after transmission of DS 2300 according to embodiments of the present disclosure. The embodiment of a channel being sensed as busy after transmission of DS 2300 shown in FIG. 23 is for illustration only. Other embodiments of a channel being sensed as busy after transmission of DS 2300 could be used without departing from the scope of this disclosure.

As shown in FIG. 23, according to one embodiment, when the medium is sensed as busy as per PHY or virtual CS mechanisms following the transmission of a DS, the STA can transmit DS at the next time boundary if it remains eligible to initiate PEDCA.

According to one embodiment, the STA can increment the PEDCA retry count by 1 each time the channel is sensed as busy as per the PHY or virtual CS mechanisms following the transmission of a DS.

According to one embodiment, the STA can keep the PEDCA retry count the same each time the channel is sensed as busy as per the PHY or virtual CS mechanisms following the transmission of a DS.

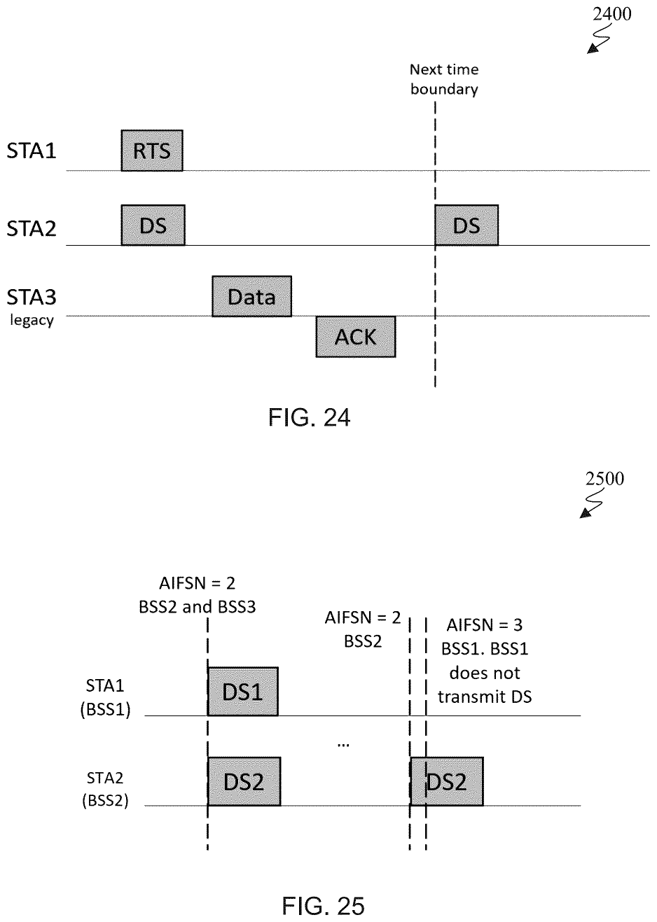

FIG. 24 illustrates an example of a channel being captured by a legacy STA following a DS transmission 2400 according to embodiments of the present disclosure. The embodiment of a channel being captured by a legacy STA following a DS transmission 2400 shown in FIG. 24 is for illustration only. Other embodiments of a channel being captured by a legacy STA following a DS transmission 2400 could be used without departing from the scope of this disclosure.

According to one embodiment, if following the DS transmission if a legacy STA captures the channel, the STA can transmit the DS at the next time boundary.

According to one embodiment, the STA can increment the PEDCA retry count by 1 each time the channel is captured by a legacy STA.

According to one embodiment, the STA can keep the PEDCA retry count the same each time each time the channel is captured by a legacy STA.

FIG. 25 illustrates an example of DS collision between OBSS 2500 according to embodiments of the present disclosure. The embodiment of DS collision between OBSS 2500 shown in FIG. 25 is for illustration only. Other embodiments of DS collision between OBSS 2500 could be used without departing from the scope of this disclosure.

As shown in FIG. 25, according to one embodiment, if the DS collides with a non-identical DS from an OBSS, there can be issues initiating the prioritized contention period following the DS transmission. In such a case, there can be repeated failures to initiate a prioritized contention period, and the STAs can randomize their DS transmission time boundary. For instance, each BSS AP can announce an AIFSN value in its beacons (either by randomizing the value on its own or via coordination with another AP). This can ensure that the DSs do not collide again.

In one embodiment, a STA that is undergoing roaming can reset the values that are used to determine its eligibility. Thus, the STA can start fresh with the new AP upon roam.

In one embodiment, a STA can carry forward the values at the time of roam. For instance, if the STA is invoking such an enhanced procedure based on a retry count value, the value stored at the STA can be carried forwarded from the current AP to the target AP.

In one embodiment, the value can be carried forward only if a certain condition is met. For instance, if the value obtained its current state due to the uplink pause during roaming phase or closer to it, then it can be carried forward to the target AP. In one example, when the STA invokes a priority EDCA based on an incurred delay value (i.e., the amount of time for which the packet was in the queue due to STA's inability to capture channel) and the delay value was incremented due to the uplink pause during roaming phase, then the STA can carry forward such a parameter value to the target AP.

In one embodiment, a STA can make an indication during a roaming procedure how it intends to handle the value at the time of roam. For example, the STA can transmit a message that can make the indication to its current AP/target AP as a part of the roaming procedure.

The message can contain at least one or more of the information items as indicated in Table 2.

TABLE 2
Information items that can be present in the message

| Information | |
|---|---|
| item | Description |
| Parameter | One or more information items that can describe |
| indication | the parameter that the STA uses to invoke the |
| | prioritized EDCA. |
| Parameter | One or more information items that can describe |
| handling | the process by which the STA can handle the |
| indication | parameters. |

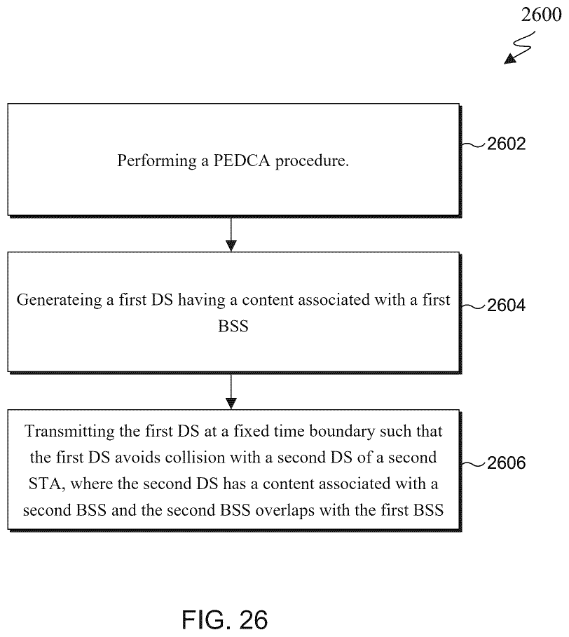

FIG. 26 illustrates an example method 2600 performed by a STA in a wireless communication system according to embodiments of the present disclosure. The method 2600 of FIG. 26 can be performed by any of the STAs 111-114 of FIG. 1, such as the STA 111 of FIG. 3, and a corresponding method can be performed by any of the APs 101-103 of FIG. 1, such as AP 101 of FIG. 2. The method 2600 is for illustration only and other embodiments can be used without departing from the scope of the present disclosure.

As illustrated in FIG. 26, the method 2600 begins at step 2602, where the STA performs a PEDCA procedure. At step 2604, the STA generates a first DS having a content associated with a first BSS. At step 2606, the STA transmits the first DS at a fixed time boundary such that the first DS avoids collision with a second DS of a second STA. The second DS has a content associated with a second BSS, and the second BSS overlaps with the first BSS.

In some embodiments, the content of the first DS is common with the content of the second DS.

In some embodiments, the first DS comprises a clear to send (CTS) frame; a value of a duration field in the first DS is common with a value of a duration field in the second DS; and a value of an address field in the first DS is common with a value of an address field in the second DS.

In some embodiments, the fixed time boundary associated with the transmission of the first DS is different than a fixed time boundary associated with transmission of the second DS.

In some embodiments, the STA receives a response frame to the first DS to initiate the PEDCA procedure.

In some embodiments, the STA determines when the STA fails to enter into a PEDCA contention phase after transmission of the first DS; increments a value of a PEDCA initiation failed count associated with the failure to enter into the PEDCA contention phase; and determines that the STA is ineligible to initiate the PEDCA procedure when the value of the PEDCA initiation failed count exceeds a threshold value.

In some embodiments, the STA determines that a DS collision occurs and that a channel is captured by another STA following transmission of the first DS; determines that the STA is eligible to initiate the PEDCA procedure; and transmits the first DS at a next time boundary.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A station (STA) comprising:
a transceiver; and
a processor operably coupled with the transceiver, the processor configured to:
perform a prioritized enhanced distributed channel access (PEDCA) procedure, wherein to perform the PEDCA, the processor is configured to:
generate a first defer signal (DS) having a content associated with a first basic service set (BSS); and
transmit, via the transceiver, the first DS at a fixed time boundary such that the first DS avoids collision with a second DS of a second STA, the second DS having a content associated with a second BSS that overlaps with the first BSS.

2. The STA of claim 1, wherein the content of the first DS is common with the content of the second DS.

3. The STA of claim 2, wherein:
the first DS comprises a clear to send (CTS) frame;
a value of a duration field in the first DS is common with a value of a duration field in the second DS; and
a value of an address field in the first DS is common with a value of an address field in the second DS.

4. The STA of claim 1, wherein the fixed time boundary associated with the transmission of the first DS is different than a fixed time boundary associated with transmission of the second DS.

5. The STA of claim 1, wherein the processor is further configured to receive, via the transceiver, a response frame to the first DS to initiate the PEDCA procedure.

6. The STA of claim 1, wherein to perform the PEDCA, the processor is further configured to:
determine when the STA fails to enter into a PEDCA contention phase after transmission of the first DS;
increment a value of a PEDCA initiation failed count associated with the failure to enter into the PEDCA contention phase; and
determine that the STA is ineligible to initiate the PEDCA procedure when the value of the PEDCA initiation failed count exceeds a threshold value.

7. The STA of claim 1, wherein to perform the PEDCA, the processor is further configured to:
determine that a DS collision occurs and that a channel is captured by another STA following transmission of the first DS;
determine that the STA is eligible to initiate the PEDCA procedure; and
transmit the first DS at a next time boundary.

8. An access point (AP) comprising:
a transceiver; and
a processor operably coupled with the transceiver, the processor configured to:
perform a prioritized enhanced distributed channel access (PEDCA) procedure, wherein to perform the PEDCA, the processor is configured to:
receive, via the transceiver, a first defer signal (DS) having a content associated with a first basic service set (BSS) from a first station (STA) and a second DS having a content associated with a second BSS from a second STA, wherein the first BSS overlaps with the second BSS; and
coordinate with a second AP such that the content of the first DS is common with the content of the second DS and that the first DS avoids collision with the second DS.

9. The AP of claim 8, wherein the processor is configured to coordinate a common time boundary with the second AP such that the first DS and the second DS are received from the common time boundary.

10. The AP of claim 9, wherein a value of a duration field in the first DS is common with a value of a duration field in the second DS.

11. The AP of claim 9, wherein a value of an address field in the first DS is common with a value of an address field in the second DS.

12. The AP of claim 8, wherein the processor is further configured to transmit, via the transceiver, a response frame to the first DS to initiate the PEDCA procedure.

13. The STA of claim 1, wherein to perform the PEDCA, the processor is further configured to:
coordinate, with the second AP, a first time boundary associated with the reception of the first DS; and
coordinate, with the second AP, a second time boundary different from the first time boundary associated with the reception of the second DS.

14. A method of wireless communication performed by a station (STA), the method comprising:
performing a prioritized enhanced distributed channel access (PEDCA) procedure, the PEDCA procedure comprising:
generating a first defer signal (DS) having a content associated with a first basic service set (BSS); and
transmitting the first DS at a fixed time boundary such that the first DS avoids collision with a second DS of a second STA, the second DS having a content associated with a second BSS that overlaps with the first BSS.

15. The method of claim 14, wherein the content of the first DS is common with the content of the second DS.

16. The method of claim 15, wherein:
the first DS comprises a clear to send (CTS) frame;
a value of a duration field in the first DS is common with a value of a duration field in the second DS; and
a value of an address field in the first DS is common with a value of an address field in the second DS.

17. The method of claim 14, wherein the fixed time boundary associated with the transmission of the first DS is different than a fixed time boundary associated with transmission of the second DS.

18. The method of claim 14, further comprising receiving a response frame to the first DS to initiate the PEDCA procedure.

19. The method of claim 14, further comprising:
determining when the STA fails to enter into a PEDCA contention phase after transmission of the first DS;
incrementing a value of a PEDCA initiation failed count associated with the failure to enter into the PEDCA contention phase; and
determining that the STA is ineligible to initiate the PEDCA procedure when the value of the PEDCA initiation failed count exceeds a threshold value.

20. The method of claim 14, further comprising:
determining that a DS collision occurs and that a channel is captured by another STA following transmission of the first DS;
determining that the STA is eligible to initiate the PEDCA procedure; and
transmitting the first DS at a next time boundary.
